(19) United States
(12) Patent Application Publication
(10) Pub. No.: US 2015/0076735 A1
(43) Pub. Date: Mar. 19, 2015

(54) INJECTION MOLDING MACHINE

(71) Applicant: Tyco Electronics Corporation, Berwyn, PA (US)

(72) Inventor: William James Moyer, II, Selinsgrove, PA (US)

(73) Assignee: Tyco Electronics Corporation, Berwyn, PA (US)

(21) Appl. No.: 14/027,978

(22) Filed: Sep. 16, 2013

(51) Int. Cl. B29C 45/06

(52) U.S. Cl. CPC B29C 45/06; B29C 2045/067
USPC 264/297.3; 425/575; 425/576; 264/297.2

(57) ABSTRACT

An injection molding machine includes first and second molds each having a first mold portion and a second mold portion used to form a molded part. The injection molding machine includes a platen holding the first mold at an injection station where an injection unit injects injection material into the first mold prior to transferring the first mold away from the platen to one or more secondary stations. The second mold is positioned remote from the platen at the one or more secondary stations where the second mold is cooled, the first and second mold portions of the second mold are opened, the molded part is ejected, and the first and second mold portions of the second mold are closed prior to transferring the second mold to the platen. The opening and closing of the first and second mold portions occurs remote from the platen.

### BACKGROUND OF THE INVENTION

The subject matter herein relates generally to injection molding machines.

Injection molding is a manufacturing technique for making parts from plastic and other materials where molten material (e.g., plastic, metal, ceramic) is injected at high pressure into a mold. Injection molding is accomplished by injection molding machines that clamp mold portions together and inject molten material into the mold. Typically the mold is held together by a mechanical force imparted on the mold by a platen. Melted material is injected into the mold by an injection device. Once the molten material cools within the mold, the mold is opened (e.g., first and second mold portions are separated) and the molded part is removed. The injection molding machine has a large amount of idle time that is inherently built into the process due to the need to wait for the material to cool and harden in the mold prior to opening the mold. Conventional injection molding machines incorporate the mold into the platen that clamps the mold and receives the injection material. The cycle is completed when the mold is opened and the part is ejected.

The number of parts that may be produced by an injection molding machine is dependent on the cycle time of the process. The cycle time is determined by the time required to inject the molten injection material into the mold, solidify the injection material, open the mold, eject the part(s) and close the mold.

A need remains for an injection molding machine having reduced cycle time and increased throughput.

### BRIEF DESCRIPTION OF THE INVENTION

In one embodiment, an injection molding machine is provided that includes first and second molds each having a first mold portion and a second mold portion used to form a molded part. The injection molding machine includes a platen holding the first mold at an injection station where an injection unit injects injection material into the first mold prior to transferring the first mold away from the platen to one or more secondary stations. The second mold is positioned remote from the platen at the one or more secondary stations where the second mold is cooled, the first and second mold portions of the second mold are opened, the molded part is ejected, and the first and second mold portions of the second mold are closed prior to transferring the second mold to the platen. The opening and closing of the first and second mold portions occurs remote from the platen.

Optionally, the one or more secondary stations may include a mold opening station having a mold opening unit. The first mold may be transferred to the mold opening unit in a closed state after the injection material is injected into the first mold at the injection station. Optionally, the one or more secondary stations may include a mold closing station having a mold closing unit. The first mold may be transferred to the mold closing unit from the mold opening unit in an open state. The first mold may be closed by the mold closing unit prior to transferring the first mold to the injection station. Optionally, the one or more secondary stations may include an ejection station between the mold opening station and the mold closing station. The first mold may be transferred from the mold opening station to the ejection station in the open state. The molded part may be ejected from the first mold at the ejection station. The first mold may be transferred to the mold closing station from the ejection station in the open state.

Optionally, the first mold portion may be movable away from the second mold portion to an open position. The first mold portion may enter the injection station and leave the injection station in a closed position.

Optionally, the injection molding machine may include a rotary wheel. The first and second mold may be mounted to the rotary wheel and may be moved from the injection station to the one or more secondary stations by the rotary wheel. The rotary wheel may stop the first mold at one of the injection station or one of the one or more secondary stations for processing. The rotary wheel may stop the second mold at a different one of the injection station or one of the one or more secondary stations,

Optionally, the injection molding machine may include locking elements used to hold the first and second mold portions relative to one another. The locking elements may hold the first and second mold portions closed as the first mold is transferred away from the platen. The one or more secondary stations may include a mold opening station remote from the injection station. The locking elements may be released at the mold opening station to allow the mold to open.

Optionally, the platen may press against the first mold at the injection station to hold the first and second mold portions closed during the injection process and may release from the first mold prior to transferring the first mold to the one or more secondary stations. The first and second mold portions may remain closed when the platen releases from the mold.

Optionally, the injection molding machine may include a third mold positioned remote from the platen at a corresponding one of the one or more secondary stations when the first mold is at the injection station. The injection molding machine may include a fourth mold positioned remote from the platen at a corresponding one of the one or more secondary stations when the first mold is at the injection station.

In a further embodiment, an injection molding machine is provided that includes a rotary wheel, a plurality of molds mounted to the rotary wheel each having a first mold portion and a second mold portion used to form a molded part, an injection unit at an injection station for injecting injection material into a corresponding mold during an injection process and a platen at the injection station for holding closed the corresponding mold during the injection process. The rotary wheel is rotated to move the plurality of molds into the injection station during the injection process and then out of the injection station to one or more secondary stations where such molds are cooled, the first and second mold portions are opened, the molded part is ejected, and the first and second mold portions are closed prior to transferring such second mold back to the injection station.

In a further embodiment, a method of injection molding molded parts is provided that includes positioning a first mold at an injection station, where the first mold has a first mold portion and a second mold portion used to form a molded part. The method includes clamping the first and second mold portions at the injection station using a platen, injecting injection material into the first mold at the injection station, and transferring the first mold away from the injection station. The method includes opening the first and second mold portions remote from the platen, ejecting the molded part from the first mold remote from the platen, and closing the first mold remote from the platen. A second mold is positioned remote from the platen when the first mold is positioned at the injection station. The second mold is positioned at the injection station when the first mold is at least one of being opened, having the molded part ejected from the first mold, or being closed.

### BRIEF DESCRIPTION OF THE DRAWINGS

FIG. 1 illustrates an injection molding machine formed in accordance with an exemplary embodiment.

FIG. 2 illustrates a portion of the injection molding machine formed in accordance with an exemplary embodiment.

FIG. 3 illustrates a portion of the injection molding machine formed in accordance with an exemplary embodiment.

FIG. 4 illustrates a portion of the injection molding machine formed in accordance with an exemplary embodiment.

FIG. 5 is a chart illustrating processing of molded parts using the injection molding machine.

### DETAILED DESCRIPTION OF THE INVENTION

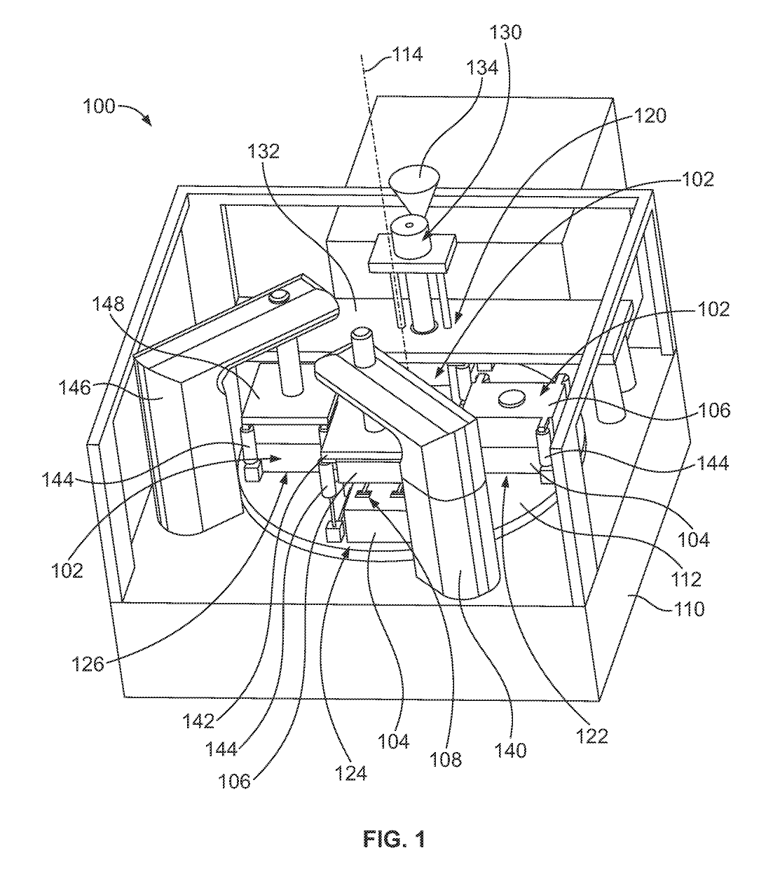

FIG. 1 illustrates an injection molding machine 100 formed in accordance with an exemplary embodiment. The injection molding machine 100 is used to manufacture molded parts. The injection molding machine 100 includes a plurality of molds 102 used to form the molded parts. Each mold 102 includes a first mold portion 104 and a second mold portion 106. Injection material is injected into a cavity 108 in the molds 102 between the first and second mold portions 104, 106. Optionally, the molds 102 may be identical to form the same molded part. Alternatively, one or more of the molds 102 may be different to form different parts. For example, the cavity 108 may have a different shape in different molds 102 to form different shaped molded parts.

The injection molding machine 100 includes a frame 110. A rotary wheel 112 is mounted to the frame 110 and is rotatable by an electric motor (not shown) about an axis of rotation 114. In an exemplary embodiment, the rotary wheel 112 is oriented horizontally (in an X-Y plane) and the axis of rotation 114 is substantially vertical (along a Z direction). Alternatively, the rotary wheel 112 may be oriented along a different plane, such as a vertical plane. The molds 102 are mounted on the rotary wheel 112. Rotation of the rotary wheel 112 in a clockwise direction (in the direction of arrow A) positions each mold 102 successively at a plurality of stations. Among the stations are an injection station 120 where the injection material is injected into the mold 102 at the injection station 120. One or more other secondary stations are provided downstream of the injection station 120.

In an exemplary embodiment, the injection molding machine includes a cooling station 122, a mold opening station 124 and a mold closing station 126. The molded parts are cooled at the cooling station 122. The molds 102 are opened at the mold opening station 124. The molded parts may be ejected from the mold 102 at the mold opening station 124. Alternatively, the injection molding machine 100 may include an additional station, such as an ejection station, where the molded parts are ejected from the mold 102. The mold 102 is closed at the mold closing station 126 prior to the mold 102 being transferred back to the injection station 120 to mold a new molded part. Other stations may be provided in alternative embodiments. Any of the secondary stations may be combined in alternative embodiments.

In an exemplary embodiment, the first and/or second mold portions 104, 106 are movable relative to one another between open and closed states. The injection material may be injected into the mold 102 when the second mold portion 106 is in a closed state. In the open state, the molded part may be ejected and removed from the cavity 108 of the mold 102. The first mold portion 104 may be a stationary or fixed mold portion mounted to the rotary wheel 112 and the second mold portion 106 may be a movable mold portion movable with respect to the first mold portion 104. The first mold portion may be referred to hereinafter as fixed mold portion 104 and the second mold portion 106 may be referred to hereinafter as movable mold portion 106. Optionally, the second mold portion 106 may be movable in a substantially vertically direction (along the Z direction),

In an exemplary embodiment, both the fixed mold portion 104 and the movable mold portion 106 of each mold 102 is movable by the rotary wheel 112 to each of the stations 120, 122, 124, 126. As such, each of the functions or processes of the injection molding process may be performed independently. For example, the cooling and ejection of the molded parts may be performed at a location remote from the injection station 120. The overall cycle time for manufacturing the molded parts may be reduced by allowing one mold to cool while a molded part is removed from a different mold and while yet another mold 102 is being injected with injection material. The throughput of the molded parts from the injection molded machine 100 is improved by decoupling the different molding processes and allowing the different molding processes to occur at different locations or stations. Providing multiple molds 102 with the fixed and movable mold portions 104, 106 allows the different molding processes to occur at different locations or stations.

The injection molding machine 100 includes an injection unit 130 at the injection station 120. The injection unit 130 may be any appropriate injection unit capable of injecting material into the mold 102. The injection unit 130 may be a hydraulic injector, and electric ejector, a screw type injector or another type of injector.

The injection molding machine 100 includes a platen 132 at the injection station 120. The platen 132 applies pressure (force) to the mold 102 to hold the first and second mold portions 104, 106 in the closed state during injection of injection material into the mold 102 at the injection station 120. The platen 132 may include any appropriate mechanical assembly such as, for example, hydraulic cylinders and/or mechanical linkages, to allow the platen 132 to open and close against the mold 102. The platen 132 may be connected to the frame 110 and may be movable relative to the frame 110 between clamped and unclamped positions.

During the molding process, once one of the molds 102 is positioned at the injection station 120, the platen 132 may be moved to the clamped position to hold the mold 102 closed. The platen 132 receives material from a nozzle 134 of the injection unit 130. The platen 132 has a flow channel (not shown) that extends through the platen 132. The flow channel may be aligned with a runner within the mold 102 that extends into the cavity 108. Injection material may be injected into the mold 102 from the nozzle 134 through the flow channel. The injection material, for example pellets, may be supplied to the nozzle 134 from a hopper (not shown). The injection unit 130 receives the injection material and forces the injection material into the mold 102. The injection unit 130 may include a heating unit to melt the injection material into a molten state. During each cycle, the injection unit 130 provides a shot of injection material that fills the internal cavity 108 of the mold 102. Optionally, the injection material may be a plastic resin material. The injection material may be polypropylene, polyvinyl chloride (PVC), polycarbonate, polyethylene terephthalate (PET), and the like. The injection material may be a non-polymer material in alternative embodiments, such as glass, metal, and the like.

Once the injection material is injected into the mold 102, the platen 132 may be unclamped to release the mold 102. The rotary wheel 112 may then transition the mold 102, including both the fixed mold portion 104 and the movable mold portion 106, to the cooling station 122. At the cooling station 122, the injection material within the mold 102 cools and hardens. Such cooling and hardening may occur at the cooling station 122 while another mold 102 is injected with injection material at the injection station 120. As such, a second mold 102 may be injected during the time period in which the previous mold 102 is cooling. The cycle time for producing the molded parts may thus be reduced.

Once the mold 102 is cooled, the rotary wheel 112 transitions the mold 102 to the mold opening station 124. The injection molding machine 100 includes a mold opening unit 140 at the mold opening station 124. The mold opening unit 140 is used to open the mold 102 for extraction of the molded part. Any type of mold opening unit 140 may be used to open the mold 102. In an exemplary embodiment, the mold opening unit 140 includes an opening device 142 that engages the second mold portion 106 and moves the second mold portion 106 to an open position. The opening device 142 may mechanically engage the second mold portion 106 to move the second mold portion 106 to an open position. The opening device 142 may be mechanically coupled to the second mold portion 106, such as by a threaded connection, a latching connection, a clamping connection, and the like. Alternatively, the opening device 142 may be connected to the second mold portion 106 by a magnetic connection, a vacuum connection, or another type of connection. The opening device 142 may include a cam system for opening the second mold portion 106. For example, the cam system may have a cam that engages cam followers on the top, bottom or sides of the second mold portion 106 to separate and open the movable mold portion 106. The opening device 142 may be electrically driven, hydraulically driven or driven by other means.

In an exemplary embodiment, the injection molding machine 100 includes locking elements 144 that are used to secure the second mold portion 106 in a closed state. For example, the locking elements 144 may be secured to the rotary wheel 112 along exterior sides of the mold 102. The locking elements 144 may engage the first mold portion 104 and/or the second mold portion 106. The locking elements 144 may be used to secure the first mold portion 104 to the rotary wheel 112. The locking elements 144 may be coupled to the second mold portion 106 to hold the second mold portion 106 in the closed state. The locking element 144 may be unlocked to allow the second mold portion 106 to move to the open state. For example, the opening device 142 may overcome any locking force of the locking elements 144 to allow the second mold portion 106 to move to the open state. In an exemplary embodiment, the locking elements 144 may be configured to hold the second mold portion 106 in the open state to allow the mold 102 to be transferred from the mold opening station 124 to the mold closing station 126.

Once the mold 102 is opened, the molded parts may be ejected from the mold 102. Optionally, the molded parts may be ejected using a robot having a gripper or vacuum for removing the molded part from the mold 102. Alternatively, an operator may remove the molded part from the mold 102. Optionally, the mold 102 may be transferred from the mold opening unit 140 at the mold opening station 124 to another station, such as an ejection station, where the molded part may be ejected from the mold 102, rather than ejecting the molded part at the mold opening station 124.

Once the mold 102 is transferred to the mold closing station 126, the mold 102 may be closed. For example, the movable mold portion 106 may be moved to the closed state. The injection molding machine 100 includes a mold closing unit 146. The mold closing unit 146 includes a closing device 148. Any type of mold closing unit 146 may be used to open the mold 102. In an exemplary embodiment, the closing device 148 engages the second mold portion 106 and moves the second mold portion 106 to a closed position. The closing device 148 may mechanically engage the second mold portion 106 to move the second mold portion 106 to the closed position. The closing device 148 may be mechanically coupled to the second mold portion 106, such as by a threaded connection, a latching connection, a clamping connection, and the like. Alternatively, the closing device 148 may be connected to the second mold portion 106 by a magnetic connection, a vacuum connection, or another type of connection. The closing device 148 may include a cam system for closing the second mold portion 106. The closing device 148 may be electrically driven, hydraulically driven or driven by other means.

After the mold 102 is closed, the mold 102 may be transferred back to the injection station 120 where injection material may again be injected into the mold 102. The mold 102, including the fixed mold portion 104 and movable mold portion 106, is transferred to the injection station 120 by the rotary wheel 112 in the closed state. The fixed mold portion 104 and movable mold portion 106, which is separate and discrete from the platen 132, is positioned below the platen 132. Once positioned, the platen 132 may be clamped against the mold portions 104, 106 to hold the mold closed during the injection process.

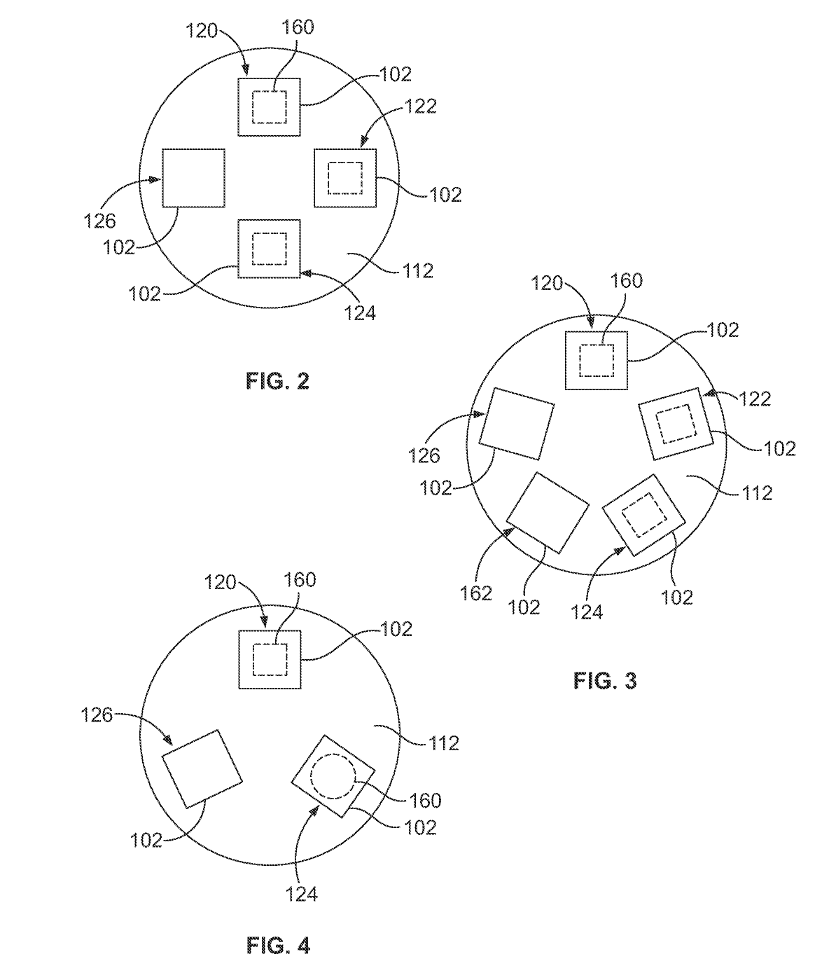

FIG. 2 illustrates a portion of the injection molding machine 100 formed in accordance with an exemplary embodiment. The rotary wheel 112 is illustrated with the molds 102 mounted thereto. Molded parts 160 are shown in phantom in some of the molds 102. The molds 102 are located at the injection station 120, cooling station 122, mold opening station 124, and mold closing station 126. The molds 102 are positioned equidistant from one another about the rotating wheel 112, such as at 90° from one another. The molded parts 160 are ejected from the molds 102 when the molds 102 are open, such as at the mold opening station 124 or the mold closing station 126.

FIG. 3 illustrates a portion of the injection molding machine 100 formed in accordance with an exemplary embodiment. FIG. 3 shows the rotary wheel 112 with a plurality of the molds 102 mounted thereto. FIG. 3 illustrates five stations, including an ejection station 162, in addition to the injection station 120, cooling station 122, mold opening station 124, and mold closing station 126. The stations are located equidistant apart at approximately 72° apart from one another. The molded parts 160 are ejected from the molds 102 at the ejection station 162.

Providing an ejection station 162 in addition to the other stations may increase the throughput of the injection molding machine 100 by reducing the total cycle time for processing the molds 102 and molded parts 160. For example, in the embodiment having four stations (FIG. 2), the time period needed to process the molds 102 and molded parts 160 at the mold opening station 124 may be longer than the processing time at any other station because both the mold opening process and the molded part ejection process occurs at the mold opening station 124. By adding an additional station, such as the ejection station 162 (FIG. 3), the waiting time per station may be reduced. Such reduction and waiting time per station equates to a faster cycle time for the injection molding machine 100, allowing more molded parts 160 to be manufactured per hour.

FIG. 4 illustrates a portion of the injection molding machine 100 formed in accordance with an exemplary embodiment. FIG. 4 illustrates the rotary wheel 112 having a plurality of molds 102 mounted thereto. Three stations are illustrated in FIG. 4. For example, the injection station 120, mold opening station 124 and mold closing station 126 are provided. The stations are located equidistant apart at approximately 120° apart from one another,

Having three stations on the rotary wheel 112, as opposed to four or five or more stations, may allow for a reduction in size of the rotary wheel 112. For example, the molds 102 may be positioned closer to one another when only three molds 102 are mounted on the rotary wheel 112. The reduction in size of the rotary wheel 112 may correspond to a reduction in size of the injection molding machine 100, allowing additional injection molding machines 100 in a given area of floor space within a factory.

The molding processes may be divided among the stations. For example, injection may occur at the injection station 120. Cooling of the mold 102 may occur at the injection station 120 prior to moving the mold 102 to the mold opening station 124. Further cooling of the mold 102 may occur at the mold opening station 124 prior to opening the mold 102. Ejection of the molded parts 160 may occur at the mold opening station 124 or the mold closing station 126.

In an exemplary embodiment, the molds 102 may be used to manufacture different molded parts 160. For example, the molded parts 160 illustrated in FIG. 4 have different shapes. It is preferable that the different molded parts 160 have similar temperature profiles (e.g. cooling rates).

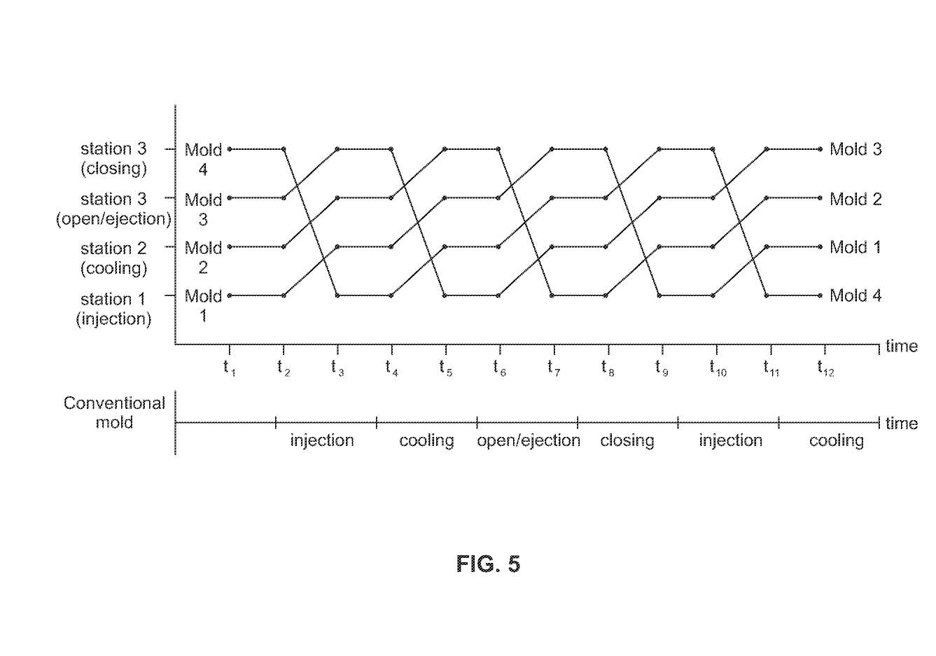

FIG. 5 is a chart illustrating processing of molded parts using the injection molding machine 100 having four stations compared to a conventional single mold injection molding machine. Both processes are shown over a time period. Both processes include the same steps of injection, cooling, opening of the mold, ejection of the molded part, and closing of the mold prior to the next injection process. With the conventional mold, there is a long wait time before the injection unit of the conventional molding machine is used to manufacture the second mold. Conversely, with the injection molding machine 100, the injection station, which is identified as station 1 in FIG. 5, has a high use rate. The high rate of use of the injection station reduces cycle time for manufacturing molded parts and increases the throughput for the injection molding machine 100.

Four molds 102 are illustrated in FIG. 5 and identified as mold 1, mold 2, mold 3, and mold 4. Each of the molds 102 is located at a different station, identified as station 1, station 2, station 3, and station 4 in FIG. 5. Station 1 is an injection station, station 2 is a cooling station, station 3 is a mold opening station and an ejection station, and station 4 is a mold closing station. The molds and molded parts are processed at each of the stations. At any particular time, each of the molds are located at a different station and remain at such station for a predetermined time period where the mold and molded part are processed. After such processing, the molds 102 are transitioned to the next station, For example, mold 1 goes from station 1 at time period T2 to station 2 at time period T3. Similarly, mold 2 transitions from station 2 to station 3, mold 3 transitions from station 3 to station 4 and mold 4 transitions from station 4 to station 1. The molds are again processed at the corresponding stations from time T3 to T4 and then the molds are again transitioned to the next station. Such processing and transition continues to occur allowing injection of different molds at each sequential time period (e.g. T1, T3, T5, T7, T9, T11).

Comparing the process of the injection molding machine 100 to the conventional machine, between T1 and T9 the injection molding machine 100 injects four shots into each of the four molds, whereas the conventional mold has only injected a single shot into the single mold of the conventional machine. Increased throughput is evidenced by the use of multiple molds and the increased use of the injection unit at the injection station. Transitioning the molds out of the injection station such that a new mold can he transferred into the injection station while other processing steps occur for the first mold reduces the cycle time and increases the throughput.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. An injection molding machine comprising:
first and second molds, the first and second molds each having a first mold portion and a second mold portion used to form a molded part; and
a platen holding the first mold at an injection station where an injection unit injects injection material into the first mold prior to transferring the first mold away from the platen to one or more secondary stations;
wherein the second mold is positioned remote from the platen at the one or more secondary stations where the second mold is cooled, the first and second mold portions are opened, the molded part ejected, and the first and second mold portions are closed prior to transferring the second mold to the platen.

2. The injection molding machine of claim 1, wherein the opening and closing of the first and second mold portions occurs remote from the platen.

3. The injection molding machine of claim 1, wherein the one or more secondary stations comprises a mold opening station having a mold opening unit, the first mold being transferred to the mold opening unit in a closed state after the injection material is injected into the first mold at the injection station.

4. The injection molding machine of claim 3, wherein the one or more secondary stations comprises a mold closing station having a mold closing unit, the first mold being transferred to the mold closing unit from the mold opening unit in an open state, the first mold being closed by the mold closing unit prior to transferring the first mold to the injection station.

5. The injection molding machine of claim 4, wherein the one or more secondary stations comprises an ejection station between the mold opening station and the mold closing station, the first mold being transferred from the mold opening station to the ejection station in the open state, the molded part being ejected from the first mold at the ejection station, the first mold being transferred to the mold closing station from the ejection station in the open state.

6. The injection molding machine of claim 1, wherein the first mold portion is movable away from the second mold portion to an open position, the first mold portion entering the injection station and leaving the injection station in a closed position.

7. The injection molding machine of claim 1, further comprising a rotary wheel, the first and second mold being mounted to the rotary wheel and moved from the injection station to the one or more secondary stations by the rotary wheel.

8. The injection molding machine of claim 7, wherein the rotary wheel stops the first mold at one of the injection station or one of the one or more secondary stations for processing and the rotary wheel stops the second mold at a different one of the injection station or one of the one or more secondary stations.

9. The injection molding machine of claim 7, further comprising locking elements used to hold the first and second mold portions relative to one another.

10. The injection molding machine of claim 9, wherein the locking elements hold the first and second mold portions closed as the first mold is transferred away from the platen.

11. The injection molding machine of claim 9, wherein the one or more secondary stations comprises a mold opening station remote from the injection station, the locking elements being released at the mold opening station to allow the mold to open.

12. The injection molding machine of claim 1, wherein the platen presses against the first mold at the injection station to hold the first and second mold portions closed during the injection process and releases from the first mold prior to transferring the first mold to the one or more secondary stations, the first and second mold portions remaining closed when the platen releases from the mold.

13. The injection molding machine of claim 1, further comprising a third mold positioned remote from the platen at a corresponding one of the one or more secondary stations when the first mold is at the injection station.

14. The injection molding machine of claim 13, further comprising a fourth mold positioned remote from the platen at a corresponding one of the one or more secondary stations when the first mold is at the injection station.

15. An injection molding machine comprising:
a rotary wheel;
a plurality of molds mounted to the rotary wheel, each mold each having a first mold portion and a second mold portion used to form a molded part;
an injection unit at an injection station for injecting injection material into a corresponding mold during an injection process; and
a platen at the injection station for holding closed the corresponding mold during the injection process;
wherein the rotary wheel is rotated to move the plurality of molds into the injection station during the injection process and then out of the injection station to one or more secondary stations where such molds are cooled, the first and second mold portions are opened, the molded part is ejected, and the first and second mold portions are closed prior to transferring such second mold back to the injection station.

16. The injection molding machine of claim 15, further comprising locking elements used to hold the first and second mold portions closed as the molds are transferred away from the platen.

17. The injection molding machine of claim 15, wherein the opening and closing of the first and second mold portions occurs remote from the platen.

18. The injection molding machine of claim 15, wherein the one or more secondary stations comprises a mold opening station having a mold opening unit and a mold closing station having a mold closing unit, the molds being transferred to the mold opening unit from the injection station in a closed state, the mold open unit separating the first and second mold portions to define an open state of the corresponding mold, the molds being transferred to the mold closing unit from the mold opening unit in the open state, the molds being closed by the mold closing unit prior to transferring the corresponding molds to the injection station.

19. A method of injection molding molded parts comprising:
positioning a first mold at an injection station, the first mold having a first mold portion and a second mold portion used to form a molded part;
clamping the first and second mold portions at the injection station using a platen;
injecting injection material into the first mold at the injection station;
transferring the first mold away from the injection station;
opening the first and second mold portions remote from the platen;
ejecting the molded part from the first mold remote from the platen; and
closing the first mold remote from the platen;
positioning a second mold remote from the platen when the first mold is positioned at the injection station; and
positioning the second mold at the injection station when the first mold is at least one of being opened, having the molded part ejected from the first mold, or being closed.

20. The method of claim 19, wherein said transferring the first mold away from the injection station comprises positioning the first mold on a rotary wheel and rotating the rotary wheel.
